(19) United States
(12) Patent Application Publication
(10) Pub. No.: US 2022/0368985 A1
(43) Pub. Date: Nov. 17, 2022

(54) CONTENT FILTERING SYSTEM BASED ON IMPROVED CONTENT CLASSIFICATION

(71) Applicant: AT&T Intellectual Property I, L.P., Atlanta, GA (US)

(72) Inventors: Binny Asarikuniyil, Cerritos, CA (US); Megha Venugopal, Torrance, CA (US)

(21) Appl. No.: 17/320,095

(22) Filed: May 13, 2021

(51) Int. Cl. H04N 21/454; G06N 20/00; H04N 21/466

(52) U.S. Cl. CPC H04N 21/4542; G06N 20/00; H04N 21/4662

(57) ABSTRACT

An example method includes training a machine learning algorithm to detect a granular level of tags associated with a media content, receiving a request to play a user selected media content, applying the machine learning algorithm that is trained to the user selected media content to identify at least one tag of the granular level of tags associated with the user selected media content, generating a notification that reports the at least one tag and a number of occurrences of the at least one tag in the user selected media content, and transmitting the notification to an endpoint device of a user that sent the request for the user selected media content to display the notification.

The present disclosure relates generally to processing media content, and relates more particularly to devices, non-transitory computer-readable media, and methods for filtering content based on improved content classification.

### BACKGROUND

Content may have general descriptions of what may be included in the content. For example, content may have rating that suggests appropriate age groups to view the content. In addition, content may have general and broad descriptions associated with the rating, such as language, violence, and the like. However, content with the same ratings and similar descriptions may still be very different. Such lack of granularity does not allow for effective parental control for content access.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for providing an improved content filtering system can be deployed;

FIG. 2 illustrates an example granular classification of media content;

FIG. 3 illustrates a flowchart of an example method for filtering media content based on granular classification of the media content, in accordance with the present disclosure; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for filtering content based on improved content classification. In one example, a method performed by a processing system includes training a machine learning algorithm to detect a granular level of tags associated with a media content, receiving a request to play a user selected media content, applying the machine learning algorithm that is trained to the user selected media content to identify the at least one tag of the granular level of tags associated with the user selected media content, generating a notification that reports the at least one tag and a number of occurrences of the at least one tag in the user selected media content, and transmitting the notification to an endpoint device of a user that sent the request for the user selected media content to display the notification.

In another example, a non-transitory computer-readable medium may store instructions which, when executed by a processing system in a communications network, cause the processing system to perform operations. The operations may include training a machine learning algorithm to detect a granular level of tags associated with a media content, receiving a request to play a user selected media content, applying the machine learning algorithm that is trained to the user selected media content to identify at least one tag of the granular level of tags associated with the user selected media content, generating a notification that reports the at least one tag and a number of occurrences of the at least one tag in the user selected media content, and transmitting the notification to an endpoint device of a user that sent the request for the user selected media content to display the notification.

In another example, a device may include a processing system including at least one processor and non-transitory computer-readable medium storing instructions which, when executed by the processing system, cause the processing system to perform operations. The operations may include training a machine learning algorithm to detect a granular level of tags associated with a media content, receiving a request to play a user selected media content, applying the machine learning algorithm that is trained to the user selected media content to identify at least one tag of the granular level of tags associated with the user selected media content, generating a notification that reports the at least one tag and a number of occurrences of the at least one tag in the user selected media content, and transmitting the notification to an endpoint device of a user that sent the request for the user selected media content to display the notification.

As discussed above, content may have broad and general descriptions of what may be included in the content. For example, content may have a broad rating (e.g., NC-17, R, PG-13, PG, and G) that suggests appropriate age groups to view the content. In addition, content may have general descriptions associated with the rating, such as language, violence, substances, and the like. However, content with the same ratings and similar descriptions may still be very different. Such lack of granularity does not allow for effective parental control for content access, thereby leading to over-inclusive parental control (e.g., limiting children access to content that may in fact be acceptable to the parents) or under-inclusive parental control (e.g., allowing children access to content that may in fact be unacceptable to the parents).

For example, two movies may have a similar rating for language and mild violence. The first movie may include gun violence where the second movie may include punching and kicking. With currently available filters, both movies may be filtered or allowed based on the same rating, e.g., violence. However, in this example one parent may actually allow their children to watch punching and kicking scenes, but not allow their children to watch gun violence scenes that may include some blood from victims of the gun violence. Thus, the broad content rating fails to allow this parent to implement the appropriate parental control as to violent scenes.

In another example, a scene in the first movie may include a suggestive scene where a person is in a towel. Although this type of scene may have no effect on the rating of the movie, one parent may not want their children to see such types of suggestive scenes. Again, the broad content rating fails to allow this parent to implement the appropriate parental control as to suggestive scenes.

In addition, the ratings may include general descriptions of content within the movie. For example, a PG-13 rating may include descriptors such as “violence” and “language.” However, these broad categories may include several different types of violence and a broad spectrum of language. A parent may allow their children to watch sword fighting, but not allow their children to watch gun fighting. A parent may allow their children to watch a gun fight scene as long as the scenes do not show blood or a person actually being shot. A parent may be more sensitive to the language their children may hear. For example, some derogatory language or some terms may not be considered profanity in today's culture. As a result, these terms may not be included in the category of “language” when rating a movie, thereby potentially exposing children to language that the parents may actually deem to be inappropriate.

As a result, when watching a movie for the first time, the parents may be surprised when a scene appears in a movie given what they believed the movie content would include based on the broad rating and general descriptions. The present disclosure provides content filtering based on improved content classification, thereby in one example providing a more effective control in terms of content access. It should be noted that although parental control is discussed in this disclosure as an example, there are other instances or scenarios where proper control over access to different types of content is important, e.g., by an educational institution educating students with content, by an airline providing content to passengers during a flight, by a daycare institution providing content while caring for children, and so on.

For example, a machine learning algorithm may be used to improve content classifications. For example, a database of media content may be tagged and labeled. Each scene of the media content (e.g., a movie, a television show, a documentary program, an uploaded video created by an individual, music, and the like) may be tagged by a service provider. The machine learning algorithm may be trained to identify these granular tags and labels within subsequently analyzed media content.

When a user requests a media content a notification may be presented to the user indicating the tags and labels that are included within the requested media content. The notification may include an account of how often each tag and/or label occurs within the media content.

In an example, the user may establish a user defined content filter that allows for the granular level of control applied to user selected media content. The user defined content filter may be submitted to the content service provider or stored at the endpoint device of the user. When the media content is played, the user defined content filter may be automatically applied to the media content. The media content may be modified in accordance with the user defined content filter. For example, undesirable words may be muted, undesirable portions of a scene may be masked, or undesirable scenes may be completely skipped or removed during playback.

In an example, the user defined content filter may include filter rules that are new to the machine learning algorithm. As a result, the new rules may be received by the content service provider and used to re-train the machine learning algorithm to identify tags and/or labels associated with the new rules received from a user. Thus, the machine learning algorithm may be continuously updated as different filter rules are received from different users. It should be noted that in one example different machine learning algorithms can be deployed for different users, e.g., a different machine learning algorithm for each user, for each household, for each institution, or for users of each geographic location, and so on. As a result, the present disclosure may provide content filtering using an improved, more granular, content classification.

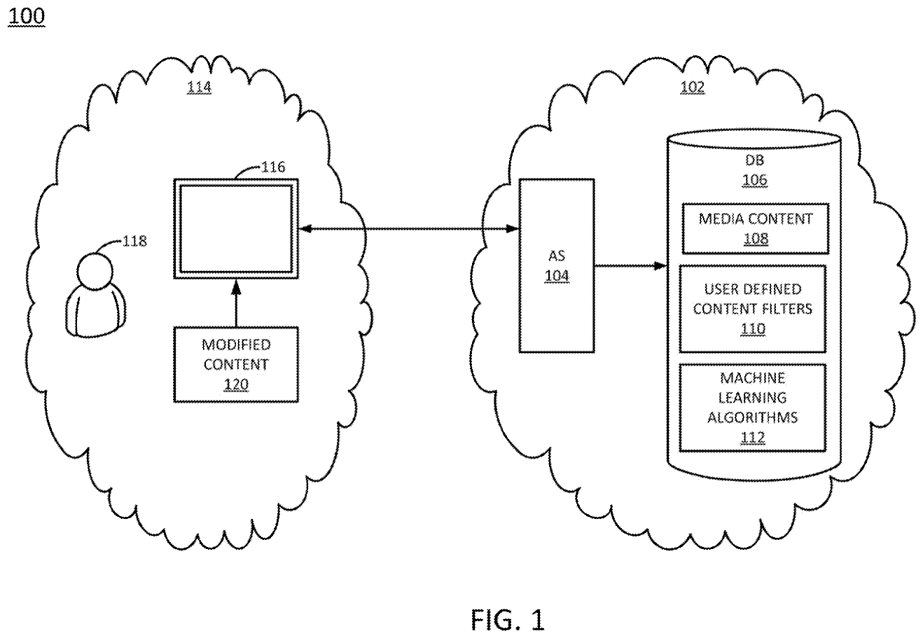

To better understand the present disclosure, FIG. 1 illustrates an example network 100, related to the present disclosure. As shown in FIG. 1, the network 100 may include a core network 102 and a home network 114. The core network 102 may be a service provider network that may provide communication services and content services (e.g., streaming media, media delivery and distribution, Internet television, and the like).

In one embodiment, the core network 102 may include an application server (AS) 104 and a database (DB) 106. The AS 104 may comprise a processing system (e.g., a processor and a memory storing instructions) that may execute the functions described herein. The AS 104 may be communicatively coupled to the DB 106. The DB 106 may store various information and/or data such as media content 108, user defined content filters 110, and one or more machine learning algorithms 112. The AS 104 may access the media content 108, the user defined content filters 110, and the machine learning algorithms 112 for processing and/or execution of the instructions stored in the DB 106. The DB 106 may also store other types of information that is not shown in FIG. 1. For example, the DB 106 may include account information, customer demographic information (e.g., members of the customer's household in terms of age, gender, and the like), account profiles, billing information, and the like.

In one embodiment, the media content 108 may include various types of content that can be accessed by a user 118 to be consumed on an endpoint device 116 in the home network 114. The media content 108 may include movies (e.g., having both image content and audio content), television shows, uploaded videos, photo albums (e.g., having image content only), songs (e.g., having audio content only), and the like.

In one embodiment, the user defined content filters 110 may store filters that include one or more tags, labels, or combination of tags defined by a user. The user defined content filters 110 may be applied to the media content 108. For example, each user 118 may have generated one or more unique or personal user defined content filters 110 that can be used to modify the media content 108 differently from other users.

The tags and/or labels used in the user defined content filters 110, may be the same tags and/or labels that are used to train the machine learning algorithms 112. The user defined content filters 110 may be generated via a user interface on the endpoint device 116 of the user 118. For example, the user defined content filters 110 may be generated via a web page hosted by the AS 104 for a service provider of the media content 108. Further details on how the user defined content filters 110 are generated are discussed in further details below.

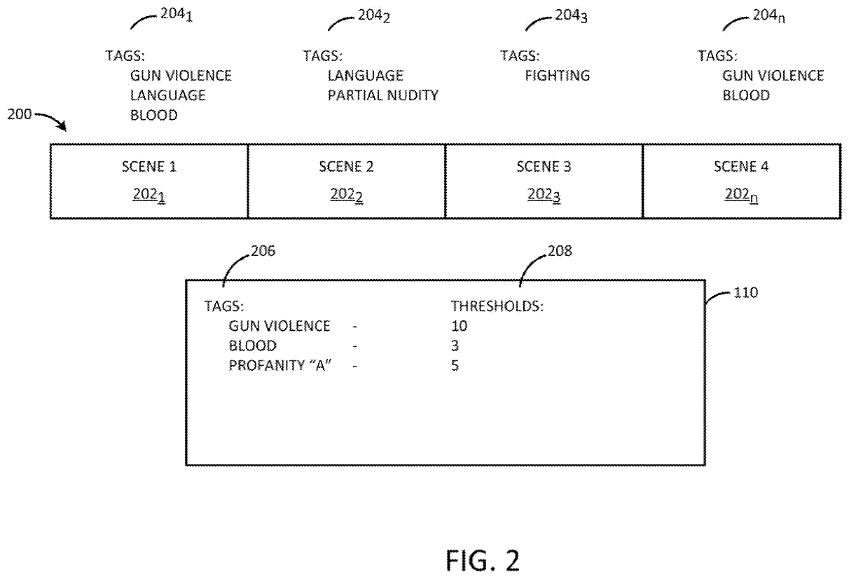

In one embodiment, the tags and/or labels in the user defined content filters 110 may be new. In other words, the user 118 may select new tags and/or labels that were not considered when initially training the machine learning algorithms 112. Thus, the AS 104 may identify the new tags, labels, or combination of different tags or labels in the user defined content filters 110. The AS 104 may then re-train the machine learning algorithms 112 to identify the new tags. The machine learning algorithms 112 may then be reapplied to the media content 108 to tag the media content 108 with the new tags that were newly identified. Further details about how the media content 108 can be tagged is discussed in further details below and illustrated in FIG. 2.

In one embodiment, the machine learning algorithms 112 may be executed by a machine learning model (MLM) (or machine learning (ML)-based model). In one embodiment, the MLM or ML may comprise the one or more machine learning algorithms 112 that have been “trained” or configured in accordance with input data (e.g., training data) to perform a particular service, e.g., to detect speech or other utterances in audio content, to identify words and phrases in speech and to convert to text, to identify intents and entities in natural language, to identify different types of images or scenes, and so forth. Examples of the present disclosure are not limited to any particular type of MLA/model, but are broadly applicable to various types of MLAs/models that utilize training data, such as support vector machines (SVMs), e.g., linear or non-linear binary classifiers, multi-class classifiers, deep learning algorithms/models, such as deep neural networks (DNNs), decision tree algorithms/models, k-nearest neighbor (KNN) clustering algorithms/models, hidden Markov models (HMMs), conditional random fields (CRF) models, generative adversarial networks (GANs), and so forth.

Although the core network 102 has been simplified for ease of explanation in FIG. 1, it should be noted that the core network 102 may include additional components that are not shown. For example, the core network 102 may combine core network components of a cellular network with components of a triple play service network; where triple play services include telephone services, Internet services and television services to subscribers. For example, core network 102 may functionally comprise a fixed mobile convergence (FMC) network, e.g., an IP Multimedia Subsystem (IMS) network. In addition, core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 102 may also further comprise a broadcast television network, e.g., a traditional cable provider network or an Internet Protocol Television (IPTV) network, as well as an Internet Service Provider (ISP) network.

The core network 102 may include network elements that may serve as gateway servers or edge routers to interconnect the core network 102 with other networks (e.g., the home network 114, the Internet, wireless access networks, other types of access network, and so forth). The core network 102 may also include other types of servers, such as for example, a plurality of television (TV) servers, a plurality of content servers, a plurality of application servers, an advertising server, and the like.

In one embodiment, the endpoint device 116 in the home network 114 may be communicatively coupled to the AS 104 in the core network 102 to access the media content 108. The home network 114 may be connected to the core network 102 via an access network. For example, the access network may be a Digital Subscriber Line (DSL) network, a broadband cable access network, a Local Area Network (LAN), a cellular or wireless access network, a 3^{rd} party network, and the like. For example, the operator of core network 102 may provide a cable television service, an IPTV service, or any other type of television service to subscribers via the access network. In this regard, access network may include a node, e.g., a mini-fiber node (MFN), a video-ready access device (VRAD) or the like. However, in another example node may be omitted, e.g., for fiber-to-the-premises (FTTP) installations. The access network may also transmit and receive communications between the home network 114 and core network 102 relating to voice telephone calls, communications with web servers, and so forth.

Alternatively, or in addition, the network 100 may provide television services to home network 114 via satellite broadcast. For instance, a ground station may receive television content from television servers in the core network 102 for uplink transmission to a satellite. Accordingly, the satellite may receive television content from the ground station and may broadcast the television content to a satellite receiver, e.g., a satellite link terrestrial antenna (including satellite dishes and antennas for downlink communications, or for both downlink and uplink communications), as well as to satellite receivers of other subscribers within a coverage area of the satellite. In one example, the satellite may be controlled and/or operated by a same network service provider as the core network 102. In another example, the satellite may be controlled and/or operated by a different entity and may carry television broadcast signals on behalf of the core network 102.

In one embodiment, the home network 114 may include a home gateway (not shown), which receives data/communication associated with different types of media (e.g., the media content 108). The home gateway may transmit data to various endpoint devices connected to the home gateway in the home network 114. The endpoint device 116 may then receive the data from the core network 102 via the home gateway.

In one embodiment, the endpoint device 116 may be any type of device that can consume the media content 108. For example, the endpoint device 116 may be a set top box, a network connected television set, a laptop computer, a desktop computer, a tablet computer, a mobile telephone, and the like.

In one embodiment, the user 118 may select a media content 108 stored in the DB 106 via the endpoint device 116. The machine learning algorithms 112 may be applied to the selected media content 108 to classify the user selected media content with the tags and/or labels that are identified in the user selected media content. In another embodiment, the machine learning algorithms 112 may be applied to all of the media content 108 after being trained to classify the media content 108 before any content is selected by the user 118.

In one embodiment, a notification may be transmitted for display to the endpoint device 116 of the user 118 after the request for the user selected media content is received. The notification may include a summary of the tags and/or labels of the user selected media content. The tags and/or labels may include a word or a description of each scene of the user selected media content. The tags and/or labels may include certain words detected in the audio clips associated with the user selected media content. The tags and/or labels may include a name or description of an object that is shown in a scene (e.g., a gun, body part, alcohol bottles, nude pictures, and the like). In one embodiment, the notification may include a numerical value associated with each tag and/or label that is identified. The numerical value may indicate a number of times the tag or label is detected throughout the entire video images and/or audio files of the user selected media content.

The user may decide to continue or allow playback of the user selected media content. In one embodiment, the user defined content filters 110 may be applied to the user selected media content. For example, the user selected media content may be modified in accordance with a user defined content filter 110 associated with the user 118.

In one embodiment, the user selected media content may be modified in accordance with the user defined content filter 110 to generate modified content 120. The user selected media content may be modified, e.g., by removing scenes from the user media content that include tags or labels included in the user defined content filter 110. For example, the user selected media content may have a run time of 2 hours. However, after being modified to remove scenes that include tags or labels in the user defined content filter 110, the user selected media content may have a run time of 1 hour and 55 minutes. Different users 118 may have different tags or labels included in their respective user defined content filters 110. As a result, different user selected media content may be modified differently and have different run times for different users.

In one embodiment, the user selected media content may be modified by masking portions of the video. For example, the user defined content filter 110 may include the tag “guns.” Thus, all guns within the user selected media content may be blurred or masked (e.g., with a black box or blurred box). In other words, the length of the user selected media content may be unchanged, but different portions of the video within the user selected media content may be masked. In another example, the user defined content filter 110 may include the tag “assault rifles.” Thus, all assault rifles within the user selected media content may be masked. However, hand guns may be allowed to be seen in the user selected media content. In another example, the user defined content filter 110 may include the tag “liquor bottles.” Thus, all liquor bottles within the user selected media content may be masked, but beer cans may be allowed to be seen.

In one embodiment, the user selected media content may be modified, e.g., by muting portions of the audio associated with the user selected media content. For example, the user defined content filter 110 may include a tag for one or more expletives, e.g., four letter curse words. Thus, the user selected media content may be modified to mute any expletives that may be spoken in the audio file. In one embodiment, any combination of deleting scenes, masking portions of the video, and/or muting portions of the audio may be performed to modify the user selected media content.

In one embodiment, the user defined content filters 110 may include new tags and/or labels that were not used to train the machine learning algorithms. For example, the machine learning algorithms 112 may have been trained to identify “knives” or “sharp objects.” However, the user may want to filter “shogun swords” in the user defined content filters 110. In one embodiment, the AS 104 may identify any new tags or labels in the user defined content filters 110. The new tags identified in the user defined content filters 110 may be used to retrain the machine learning algorithms 112. The machine learning algorithms 112 may then be applied to the media content 108 to tag or label the media content 108 to potentially identify the new tags.

In one embodiment, the user 118 may periodically update the user defined content filters 110 as the demographics within the household change. For example, as children in the household grow older, or younger children enter the household, the user 118 may change the user defined content filter 110. When the user defined content filter 110 is updated, the user 118 may add new tags or labels or remove existing tags or labels. Thus, the AS 104 may process the user defined content filter 110 each time a change is made by the user 118. If any new tags and/or labels are identified (or removed), the machine learning algorithms may be re-trained, as described above.

In one embodiment, the modified content 120 may be generated at the endpoint device 116 of the user 118. For example, the user selected media content may be transmitted to the endpoint device 116 where it is stored prior to playback. The user selected media content may be buffered as the user defined content filter 110 is applied to the user selected media content. The endpoint device 116 may perform the modification locally based on the user defined content filter 110 received from the AS 104. The endpoint device 116 may then encode the modified content 120 for playback.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 102 is not limited to an IMS network. Similarly, the present disclosure is not limited to an IP/MPLS network for VoIP telephony services, or any particular type of broadcast television network for providing television services, and so forth.

FIG. 2 illustrates an example of providing granular classification of the media content 108. As noted above, the machine learning algorithms 112 may be trained to provide a more granular content classification. Thus, machine learning algorithms 112 may be trained with training data that includes media content that is tagged and/or labeled. FIG. 2 illustrates how the media content 108 may be tagged or labeled by the trained machine learning algorithms 112 and an example of the user defined content filters 110.

In one embodiment, the media content 108 may be content that is managed by a service provider of the core network 102 or on a third party site. As a result, the media content 108 may be categorized and tagged. For example, each scene (e.g., one or more images) of the media content 108 may be tagged with various descriptions. A time frame (e.g., one or more time stamps) may be associated with each scene of the media content 108 and each scene may be tagged with descriptions to describe what type of information is in the scene.

FIG. 2 illustrates an example timeline 200 of a media content. The timeline 200 may include a plurality of scenes 2021 to 202n (hereinafter also referred to individually as a scene 202 or collectively as scenes 202). Each scene 202 may be defined by a start time and an end time having a plurality of frames. Each scene 2021 to 202n may include respective tags 2041 to 204n (hereinafter also referred to individually as a tag 204 or collectively as tags 204). The tags 204 may include terms or descriptions that describe what type of content is within a respective scene 202.

In one embodiment, the present disclosure may allow the user 118 to use more granular descriptions. Current descriptors of content may use general broad terms such as “violence” or “mature language.” However, there may be different types of violence. Some types of violence may be acceptable to the user 118, while other types of violence may not be acceptable to the user 118. For example, within the tag 204 of “violence” there may be supplemented with more sub categories of violence such as “gun violence,” “sword violence,” “fist fighting violence,” “karate violence,” and the like. In addition, within each sub category of violence, there may be further tags 204. For example, within “gun violence” there may be further sublevel descriptions such as “blood,” “bullet exit wounds,” “close up execution,” “assault rifles,” and the like. Thus, more granular tags 204 may be associated with training pertinent machine learning algorithms 112 and used in the user defined content filters 110.

In one embodiment, a training process may be implemented by the AS 104 to train the machine learning algorithms 112 to detect the granular tags 204. In one embodiment, the machine learning algorithms 112 may receive inputs from training data that includes media content that has been pre-labeled or tagged with the desired granular tags 204 to be detected by the machine learning algorithms. For example, if the tag “exit wounds” is a relevant tag, then the pertinent training data (e.g., media having scenes labeled with exit wounds) can be used as inputs to train the machine learning algorithms.

After the machine learning algorithms 112 are trained, the machine learning algorithms 112 may be applied to media content to identify the granular tags 204 in the media content 108. As noted above, each media content 108 may be tagged scene-by-scene. When the user 118 selects a media content 108 for playback, the AS 104 will process the granular tags 204 and generate a notification that includes a summary of the granular tags 204. The notification may include each granular tag 204 included in the media content 108 and a numerical value associated with a number of occurrences of each granular tag 204 within the media content 108. The notification may be transmitted to the endpoint device 116 of the user 118 before the media content 108 is played. The user 118 may review the notification and decide whether or not to play the media content 108. For example, the media content 108 may have a “PG” rating, but may include many tags that the user 118 does not want to allow his or her children to watch or listen to.

In one embodiment, the notification may be used to allow the user 118 to provide a user defined content classification for the user selected media content. For example, the user selected media content may be labeled as being rated “PG,” but based on the tags in the notification, the user 118 may determine that the user selected media content should be labeled as “PG-13,” “R,” “PG with gun violence,” “PG with smoking and alcohol drinking,” “PG with death scene,” and so on. Thus, the user 118 may create his or her own content classification based on the tags in the notification. For example, the user 118 may create a content classification for “PG-15” or “PG-16” so that that children in their household over 15 may watch the user selected media content, but children under 15 may not watch.

In one embodiment, the user 118 may go through the available media content 108 and create his or her own content classifications for the media content 108 based on the tags provided in the summary. As a result, the media content 108 may be more accurately classified based on the preferences or morale values of the user 118. The user defined content classifications may be stored with the media content 108 by the service provider. As a result, when a user browses the library of media content 108 using the endpoint device 116 of the user 118 when the user 118 is logged in, the media content 108 may have the content classifications assigned by the user 118. However, when a user browses the media content 108 on an endpoint device of a different user when the different user 118 is logged in, the media content 108 may be displayed with different content classifications. Thus, the content classifications for each media content can be unique to each user.

In one embodiment, the user 118 may generate user defined content filters 110. As described above, the user defined content filters 110 may be generated via a website hosted by the AS 104 associated with the content service provider of the media content 108. The user defined content filters 110 may allow media content that has been classified by the user 118 to still be viewed that may not be age appropriate for a viewer, but in a modified form. Thus, the tags that may have caused the user 118 to classify content as “R” may be modified in accordance with the user defined content filters to make the media content appropriate for a viewer.

In one embodiment, the user defined content filters 110 may include user defined granular tags 206 (also referred to herein as tags 206). The tags 206 may include any term or description desired by the user 118. In other words, the user 118 may include tags that were not included in the training data set of media content used to train the machine learning algorithms.

As noted above, when the AS 104 receives the user defined content filters 110, the user defined content filters 110 may be analyzed to identify any tags 206 that may be new or not used to previously train the machine learning algorithms 112. In an example, the AS 104 may request additional information from the user 118 to help define the newly identified tags within the user defined content filters 110. For example, the user 118 may be presented with some sample videos or scenes of the media content 108 that potentially may include scenes that relate to the newly received user identified tag. The user 118 may be asked to tag the sample videos or scenes that include the newly identified tags. The sample videos with the newly identified tags that are confirmed by the user 118, may then be provided as training data to the machine learning algorithms 112 to re-train the machine learning algorithms 112 with the newly identified tags. The machine learning algorithms 112 may then be applied to subsequent user requested media content to identify the newly identified tags in the user defined content filter 110 of the user 118.

In one embodiment, the user identified content filters 110 may also include thresholds 208. The thresholds 208 may allow the user 118 to further filter content based on a number of times a tag 206 is in the media content 108. For example, the user may want to allow their children to watch a musical. However, the musical may have Profanity “A” spoken twice during the musical. Without the thresholds, the musical may be blocked or modified in an undesirable way. In one illustrative example, a user 118 may set the threshold 208 for the tag 206 of Profanity “A” to 5 and “gun violence” to 10. Thus, if the musical has Profanity “A” spoken less than 5 times, then the media content 108 may be left unmodified with respect to the tag 206 of Profanity “A.” However, the musical may have 15 instances of gun violence. Thus, the musical may still be modified to mask the gun violence scenes, while leaving the scenes having the uttered Profanity “A” unmodified.

In one embodiment, the user identified content filters 110 may be applied to the media content 108 before the media content 108 is encoded for transmission. For example, the media content 108 may be modified to mask scenes and/or mute some audio to generate the modified content 120. The modified content 120 may then be encoded based on the type of playback encoding used by the endpoint device 116. The modified content 120 that is encoded may then be transmitted to the endpoint device 116 for playback. Thus, the modification of the media content is not performed locally at the endpoint device 116.

In another embodiment, the media content 108 may be analyzed as the media content 108 is encoded and streamed to the endpoint device 116. A copy of the user identified content filters 110 may be locally stored on the endpoint device 116. For example, a buffer may be used to encode and analyze the media content 108 in accordance with the user identified content filters 110. The media content 108 may be buffered to allow enough time for the user identified content filters 110 to be applied to a scene before the scene is played back to the user 118.

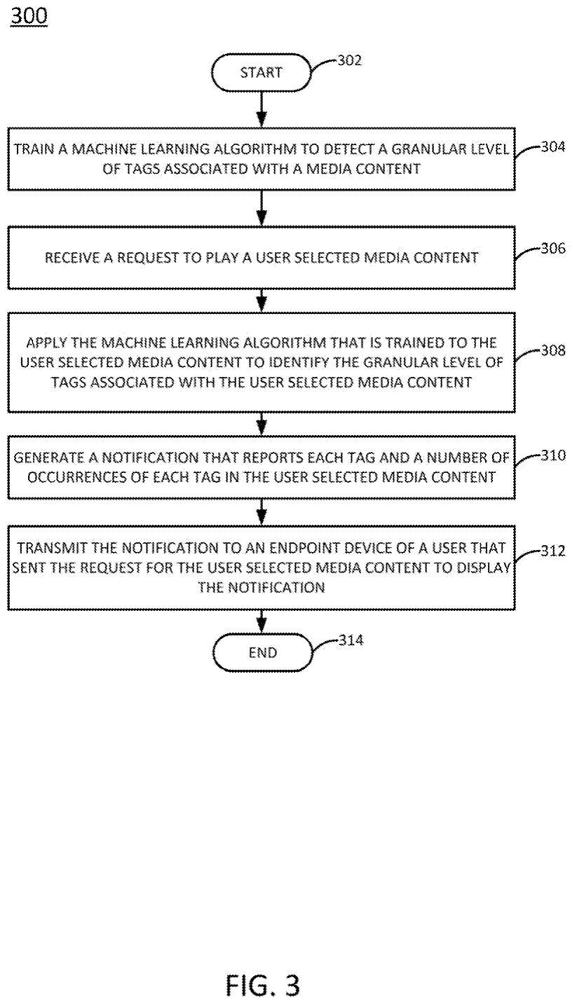

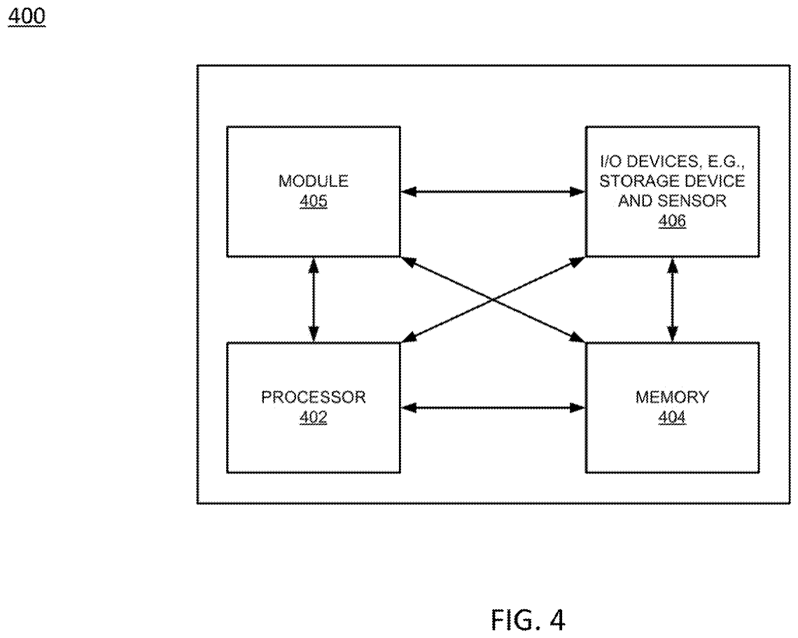

FIG. 3 illustrates a flowchart of an example method 300 for filtering media content based on granular classification of the media content, in accordance with the present disclosure. In one example, steps, functions and/or operations of the method 300 may be performed by the AS 104 as illustrated in FIG. 1. In one example, the steps, functions, or operations of method 300 may be performed by a computing device or system 400, and/or a processing system 402 as described in connection with FIG. 4 below. For instance, the computing device 400 may represent at least a portion of the AS 104 in accordance with the present disclosure. For illustrative purposes, the method 300 is described in greater detail below in connection with an example performed by a processing system, such as processing system 402.

The method 300 begins in step 302. In step 304, the processing system may train a machine learning model to detect a granular level of tags associated with a media content. For example, a training set of media content may be created by manually tagging and/or labeling various scenes and/or audio content within the media content. For example, an entire frame of a sequence of video may be tagged with labels such as “gun violence,” “blood,” “hand-to-hand combat,” “headshot,” “death,” “murder,” and the like.

In an example, portions of the frame may be tagged to identify objects in the frame. For example, the frame may be tagged with “gun” to identify guns in the background of the frame, or “suggestive” to identify an advertisement in the billboard located in the background of a scene, and so forth. Thus, the tags may not necessarily describe what is happening within the scene, but may identify one or more objects that are in the background of the scene.

In one example, the audio file may be tagged to label different types of language. For example, the tag may be broadly defined to refer to “profanity” or may be more specific to a list of particular words that constitute profanity when spoken. The tag may transcribe each word that is spoken in the entire audio file such that tags within a user defined content filter that refer to a particular word can be searched for within the audio file and muted, if necessary, as described below.

In step 306, the processing system may receive a request to play a user selected media content. For example, a user may select a media content from a library of media content available from a service provider. The media content may be downloaded and played on an endpoint device of the user or may be streamed over the Internet to the endpoint device of the user.

In step 308, the processing system may apply the machine learning model that is trained to the user selected media content to identify the granular level of tags associated with the user selected media content. For example, the machine learning model that was trained in step 304 may be applied to the media content that is selected by the user. The machine learning model may identify tags that it was trained to identify in the user selected media content.

In step 310, the processing system may generate a notification that reports each tag and/or a number of occurrences of each tag in the user selected media content. For example, the notification may be a summary that lists each tag that was identified. The summary may also include the number of occurrences. As a result, the user may still want to view the media content if a particular tag only occurs a few times (e.g., once or twice) within the user selected media content that the user may deem acceptable.

In step 312, the processing system may transmit the notification to an endpoint device of a user that sent the request for the user selected media content to display the notification. The user may view the notification and then determine whether to proceed with viewing the media content.

In one embodiment, the notification may be used to allow the user to provide a user defined content classification for the user selected media content. For example, the user selected media content may be labeled as being rated “PG,” but based on the tags in the notification, the user 118 may determine that the user selected media content should be labeled as “PG-13” or “R.” The user may also create his or her own content classification based on the tags in the notification. For example, the user may create a content classification for “PG-15” or “PG-16” so that that children in their household over 15 may watch the user selected media content, but children under 15 may not watch.

In one embodiment, the user may go through the available media content and create his or her own content classifications for the media content based on the tags provided in the summary. As a result, the media content may be more accurately classified based on the preferences or morale values of each individual user.

In one embodiment, a user may generate a user defined content filter. The user defined content filter can be created on a website hosted by a server of the content service provider. The user defined content filter may include tags and/or thresholds associated with each tag that the user would like filtered out of the content.

In one embodiment, the user defined content filter may be applied to the user selected media content. For example, the user may be provided an option after the notification is received to apply the user defined content filter. For example, the user selected media content may include many tags that the user does not want to view in the media content. As a result, the user may request the media content be modified in accordance with the user defined content filter.

In one embodiment, the media content may be modified to mask the media content in accordance with the user defined content filer. Masking the media content may include removing entire scenes associated with tags in the user defined content filter. In one embodiment, masking the media content may include adding a black box or blurring objects within portions of the video content. In one embodiment, masking the media content may include muting portions of the audio associated with the video content. In one embodiment, masking the media content may include any combination of removing video, adding a black box, blurring an object, and/or muting audio.

In one embodiment, the media content may be modified by an application server before the media content is streamed to an endpoint device of the user. In one embodiment, the media content may be downloaded to an endpoint device of the user and modified locally by the endpoint device of the user.

It should be noted that different users may have different tags in their user defined content filter. Moreover, different individuals within the same household may have different user defined content filters. For example, the parents may have a user defined content filter and the children may have a user defined content filter that is different from the user defined content filter of the parents. Thus, the same media content may be modified differently for different users. In other words, the modified content may appear differently for different users. For example, different scenes may be deleted, different portions of video may have black boxes or blurred objects, or the audio file may sound different for different users. Thus, the media content may be tailored to different users in a more granular fashion rather than the users having to rely on general content ratings with general descriptions that may not accurately describe the media content.

In one embodiment, the user defined content filter may include new tags that were not included in the training data to train the machine learning algorithms. When new tags are identified (e.g., when compared to a listing of known tags), the step 304 may be repeated with new training data that includes the new tags that are identified. The machine learning algorithm may be retrained and the method 300 may be repeated. In step 314, the method 300 ends.

It should be noted that the method 300 may be expanded to include additional steps or may be modified to include additional operations with respect to the steps outlined above. In addition, although not specifically specified, one or more steps, functions, or operations of the method 300 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for filtering media content based on granular classification of the media content, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 300 as discussed above is implemented in a distributed or parallel manner for a particular illustrative example, i.e., the steps of the above method 300 or the entire method 300 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 300. In one example, instructions and data for the present module or process 405 for filtering media content based on granular classification of the media content (e.g., a software program comprising computer-executable instructions) can be loaded into memory 404 and executed by hardware processor element 402 to implement the steps, functions, or operations as discussed above in connection with the illustrative method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for providing filtering media content based on granular classification of the media content (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

1. A method comprising:
training, by a processing system including at least one processor, a machine learning algorithm to detect a granular level of tags associated with a media content;
receiving, by the processing system, a request to play a user selected media content;
applying, by the processing system, the machine learning algorithm that is trained to the user selected media content to identify at least one tag of the granular level of tags associated with the user selected media content;
generating, by the processing system, a notification that reports the at least one tag and a number of occurrences of the at least one tag in the user selected media content; and
transmitting, by the processing system, the notification to an endpoint device of a user that sent the request for the user selected media content to display the notification.

2. The method of claim 1, further comprising:
receiving, by the processing system, a confirmation to transmit the user selected media content; and
transmitting, by the processing system, the user selected media content.

3. The method of claim 1, further comprising:
receiving, by the processing system, a user defined content filter that includes one or more tags of the granular level of tags used to train the machine learning algorithm; and
applying, by the processing system, the user defined content filter to the user selected media content.

4. The method of claim 3, wherein the processing system is part of an application server of a content service provider.

5. The method of claim 1, wherein a user defined content filter that includes one or more tags of the granular level of tags used to train the machine learning algorithm is applied to the user selected media content.

6. The method of claim 3, wherein the applying the user defined content filter is performed before the user selected media content is transmitted.

7. The method of claim 3, wherein the applying the user defined content filter is performed scene-by-scene as the user selected media content is transmitted to the endpoint device of the user.

8. The method of claim 7, wherein the user selected media content is buffered to apply the user defined content filter as the user selected media content is transmitted to the endpoint device of the user.

9. The method of claim 3, wherein the user defined content filter includes a numerical threshold for the one or more tags.

10. The method of claim 3, wherein the applying the user defined content filter comprises:
muting, by the processing system, a portion of audio that includes the one or more tags in the user defined content filter.

11. The method of claim 3, wherein the applying the user defined content filter comprises:
masking, by the processing system, a portion of video that includes the one or more tags in the user defined content filter.

12. The method of claim 3, wherein the applying the user defined content filter comprises:
modifying, by the processing system, the user selected media content to remove at least one portion of the user selected media content that includes the one or more tags in the user defined content filter.

13. The method of claim 1, further comprising:
receiving, by the processing system, a new tag to be filtered from the user selected media content; and
retraining, by the processing system, the machine learning algorithm to identify updated granular level of tags that include the new tag.

14. The method of claim 13, further comprising:
receiving, by the processing system, a second user selected media content; and
applying, by the processing system, the machine learning algorithm that is retrained to identify the updated granular level of tags associated with the second user selected media content.

15. The method of claim 1, wherein the media content includes audio and video.

16. The method of claim 1, wherein the granular level of tags comprises a word or a description.

17. A non-transitory computer-readable medium storing instructions which, when executed by a processing system including at least one processor, cause the processing system to perform operations, the operations comprising:
training a machine learning algorithm to detect a granular level of tags associated with a media content;
receiving a request to play a user selected media content;
applying the machine learning algorithm that is trained to the user selected media content to identify at least one tag of the granular level of tags associated with the user selected media content;
generating a notification that reports the at least one tag and a number of occurrences of the at least one tag in the user selected media content; and
transmitting the notification to an endpoint device of a user that sent the request for the user selected media content to display the notification.

18. The non-transitory computer-readable medium of claim 17, the operations further comprising:
receiving a confirmation to transmit the user selected media content; and
transmitting the user selected media content.

19. The non-transitory computer-readable medium of claim 17, the operations further comprising:
receiving a user defined content filter that includes one or more of the granular level of tags used to train the machine learning algorithm; and
applying the user defined content filter to the user selected media content.

20. A device comprising:
a processing system including at least one processor; and
a non-transitory computer-readable medium storing instructions which, when executed by the processing system, cause the processing system to perform operations, the operations comprising:
training a machine learning algorithm to detect a granular level of tags associated with a media content;
receiving a request to play a user selected media content;
applying, the machine learning algorithm that is trained to the user selected media content to identify at least one tag of the granular level of tags associated with the user selected media content;
generating a notification that reports the at least one tag and a number of occurrences of the at least one tag in the user selected media content; and
transmitting the notification to an endpoint device of a user that sent the request for the user selected media content to display the notification.
